(19) United States
(12) Patent Application Publication
(10) Pub. No.: US 2017/0262558 A1
(43) Pub. Date: Sep. 14, 2017

(54) COMPUTER-READABLE RECORDING MEDIUM STORING PROGRAM FOR THERMAL CONDUCTIVITY CALCULATION PROGRAM, THERMAL CONDUCTIVITY CALCULATION METHOD, AND INFORMATION PROCESSING APPARATUS

(71) Applicant: FUJITSU LIMITED, Kawasaki-shi (JP)

(72) Inventors: akihiro otsuka, Yokohama (JP); Akira Ueda, Yokohama (JP); Yasuhiro Ite, Chofu (JP); Takamasa Shinde, Kawasaki (JP); Kazuhisa Inagaki, Yokohama (JP); Akira Sakai, Kawasaki (JP); Tetsuyuki Kubota, Yokohama (JP); Hideharu Matsushita, Yokohama (JP)

(73) Assignee: FUJITSU LIMITED, Kawasaki-shi (JP)

(21) Appl. No.: 15/433,475

(22) Filed: Feb. 15, 2017

(30) Foreign Application Priority Data
Mar. 9, 2016 (JP) 2016-046238

(51) Int. Cl. G06F 17/50

(52) U.S. Cl. CPC G06F 17/5009; G06F 2217/80

(57) ABSTRACT

A non-transitory computer-readable recording medium having stored therein a program for causing a computer to execute a process for thermal conductivity calculation, the process includes receiving information indicating a surface of a first part, on which a particular part having high elasticity is disposed; receiving specification information indicating a second part in contact with the particular part; receiving information Indicating a first thickness of the particular part; calculating a second thickness of the particular part after compressed when the particular part is placed between the surface and the second part; and calculating a thermal conductivity of the compressed particular part having the second thickness, according to an amount of compression indicating a difference between the first and the second thicknesses and to a correspondence relationship between a thermal resistance of the particular part and an amount obtained by subtracting a thickness of the compressed particular part from the first thickness.

### CROSS-REFERENCE TO RELATED APPLICATION

This application is based upon and claims the benefit of priority of the prior Japanese Patent Application No. 2016-046238, filed on Mar. 9, 2016, the entire contents of which are incorporated herein by reference.

### FIELD

The embodiment discussed herein is related to a computer-readable recording medium storing program for thermal conductivity calculation program, a thermal conductivity calculation method, and an information processing apparatus.

### BACKGROUND

In the conventional design and development of apparatuses and the like, three-dimensional design based on computer-aided design (CAD) may be carried out. In a thermal fluid simulation, a fluid flow and a heat transfer are simulated by a computer. To perform a thermal fluid simulation, analysis data is created that is used to perform modeling according to CAD data for analysis purposes.

When, for example, the user uses CAD data for analysis, the user models a thermally conductive material such as a thermal interface material (TIM), an adhesive, or another part that is not included in the CAD data so as to match parts represented by the CAD data and sets a thermal conductivity according to the modeled thermally conductive material, adhesive, or other part.

In an example of related art, analysis data including thermal conductivity is created for a structure according to a thermal resistance that depends on the contact state of a contact surface with which the end surfaces of two parts in a three-dimensional model represented by three-dimensional design data are brought into contact in opposite directions (see Japanese Laid-open Patent Publication No. 2007-316032, for example). In another example of related art, parameters about a desired physical phenomenon related to a desired simulation such as a heat transfer simulation, an electromagnetism simulation, or a structural mechanics simulation may be input through a graphic user interface (GUI) (see Japanese Laid-open Patent Publication No. 2015-525937, for example).

In an aspect, an object of the present disclosure is to provide a computer-readable recording medium storing program for thermal conductivity calculation program, a thermal conductivity calculation method, and an Information processing apparatus by which a thermal conductivity is obtained in consideration of a case in which a thermally conductive material, an adhesive, or another part is expanded, preferably compressed.

### SUMMARY

According to an aspect of the invention, a non-transitory computer-readable recording medium having stored therein a program for causing a computer to execute a process for thermal conductivity calculation, the process includes: receiving specification Information indicating a surface of a first part, the first part being one of a plurality of parts included in an object to be analyzed, the object being represented by design data, the surface being one of surfaces of the first part and in contact with a particular part that is not included in the object; receiving specification information Indicating a second part in contact with the particular part, the second part being one of the plurality of parts, the particular part being more deformable than the first part and the second part; receiving specification Information indicating a first thickness of the particular part before the particular part is compressed; calculating, according to the design data, a second thickness of the particular part after the particular part has been compressed in a case in which the particular part is placed between the surface and the second part and has been compressed; and calculating a thermal conductivity of the compressed particular part having the second thickness, according to an amount of compression of the particular part indicating a difference between the first thickness and the second thickness and to correspondence Information that represents a correspondence relationship between a thermal resistance of the particular part and an amount of compression obtained by subtracting a thickness of the particular part which is compressed from the first thickness.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of the operation of an information processing apparatus according to the embodiment;

FIGS. 2A to 2C illustrate an example of modeling in analysis and an example of changes in thermal resistance;

FIG. 3 is a block diagram illustrating an example of the hardware structure of the information processing apparatus as the embodiment;

FIG. 4 is a block diagram illustrating an example of the functional structure of the information processing apparatus as the embodiment;

FIG. 5 illustrates an example of CAD data;

FIG. 6 illustrates an example of calculating a thermal conductivity when the thickness of a compressed TIM is not input;

FIG. 7 illustrates an example of calculating a thermal conductivity when the thickness of a compressed TIM is input;

FIG. 8 illustrates an example of calculating thermal conductivities at different distances between a heat generating part and a target part; and

FIG. 9 is a flowchart illustrating an example of a processing procedure executed by the information processing apparatus to calculate a thermal conductivity.

### DESCRIPTION OF EMBODIMENTS

When the user uses CAD data for analysis in the related art, however, it is difficult for the user to determine a thermal conductivity based on modeled part such as TIM or an adhesive after modeling a thermal conductive material and an adhesive which are modeled so as to adapt to parts expressed by CAD data. When the thermally conductive material, adhesive, or other part has high elasticity for example, it is easily compressed or expanded. Therefore, it takes much time and efforts for the user to model parts so as to match parts represented by the CAD data and determine a thermal conductivity.

The computer-readable recording medium storing program for thermal conductivity calculation program, thermal conductivity calculation method, and information processing apparatus according to the present embodiment will be described in detail with reference to the attached drawings.

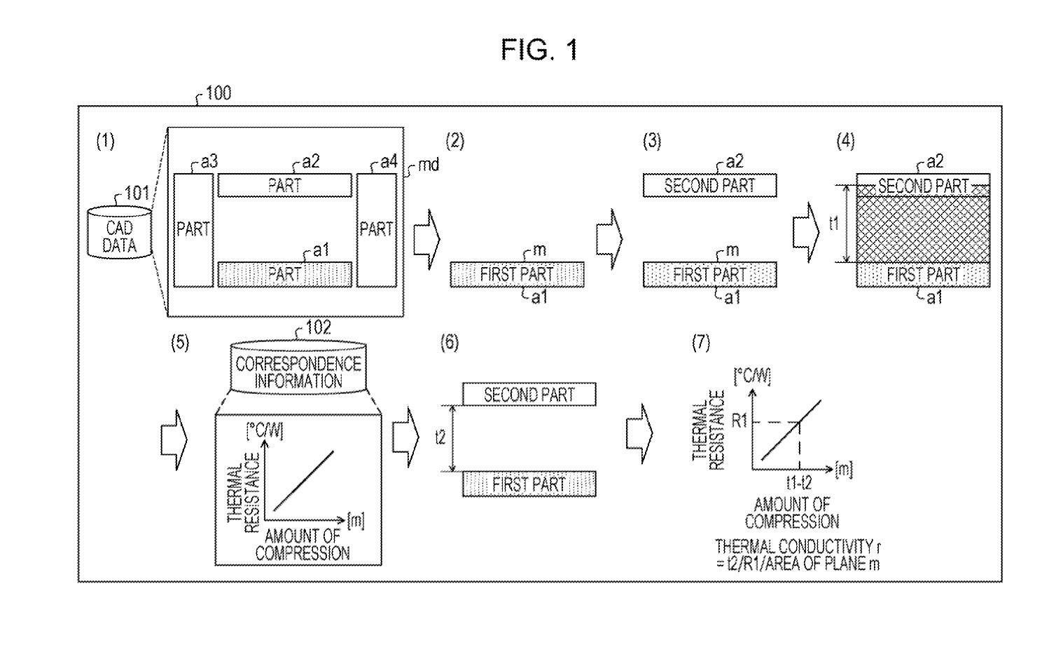

FIG. 1 illustrates an example of the operation of the Information processing apparatus according to the present embodiment. The information processing apparatus 100 is a computer or a processor that calculates the thermal conductivity of a thermally conductive material, an adhesive, or another part in an object md eligible for being analyzed in a thermal fluid simulation. The information processing apparatus 100 executes a thermal conductivity calculation program.

In the conventional design and development of apparatuses and the like, three-dimensional design based on CAD may be carried out. There is a thermal fluid simulation for simulating a fluid flow and a heat transfer carried out by a computer. To perform a thermal fluid simulation, modeling is performed based on CAD data to create analysis data to be used in analysis. In a thermal fluid simulation in recent years, CAD data as an object to be analyzed may be used without alteration.

Since a thermally conductive material and an adhesive are very thin, their data is not often included in three-dimensional CAD data. When analysis is carried out using CAD data, the user models part such as a thermally conductive material or adhesive to determine a thermal conductivity based on the part such as the modeled TIM or adhesive.

The thermally conductive material is a material having a superior thermal conductivity. The thermally conductive material and adhesive are each an elastic member having elasticity. Examples of thermally conductive materials include a TIM.

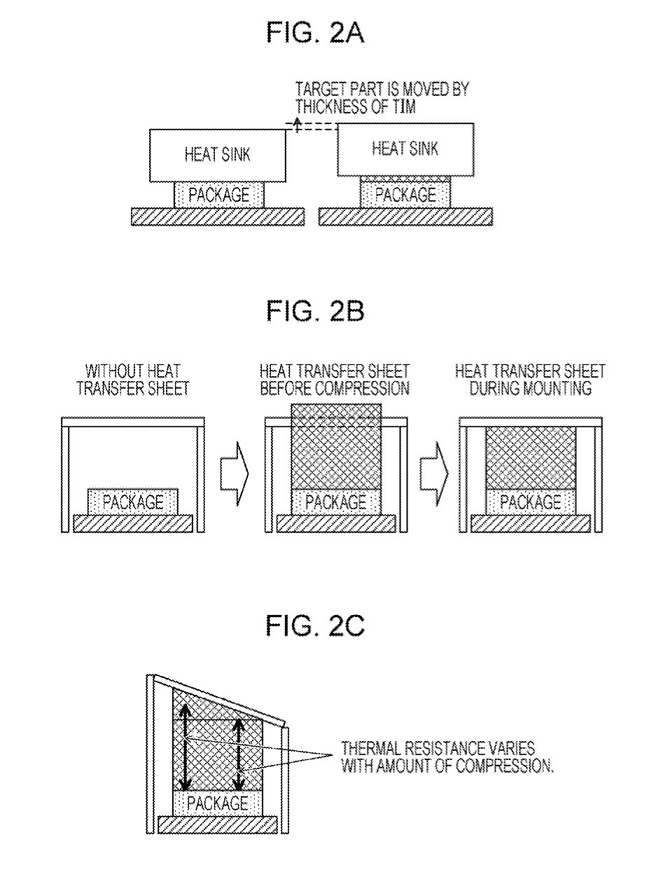

When, for example, a part such as a thermally conductive material or an adhesive is elastic, the part is deformed. Specifically, a part such as a thermally conductive material or an adhesive is an elastic member that is easily deformed, so when the part is mounted, it may be compressed as described later with reference to FIGS. 2A to 2C. Accordingly, when the user models a thermally conductive material, an adhesive, or another part in consideration of its deformation so as to match parts represented by the CAD data and determines a thermal conductivity, much time and efforts are involved. When precision with which the thermally conductive material or the adhesive is modeled is low, the precision of the thermal conductivity to be determined becomes low, resulting in a low-precision thermal analysis simulation.

In view of this, in this embodiment, the thermal conductivity of a TIM to be placed between a heat generating part and a target part is calculated according to the amount of compression of the TIM and the relationship between the amount of compression of the TIM and its thermal resistance. The amount of compression is obtained from the thickness of the TIM before the compression and its thickness after the compression. Thus, a thermal conductivity may be obtained in consideration of the compression of a thermally conductive material, an adhesive, or another part. This enables a thermal simulation may be carried out at a higher precision.

The object md is, for example, an object md that is simulated in a simulation space by using CAD. The simulation space is a virtual three-dimensional space simulated by a computer. Specifically, the simulation space is, for example, a space that is virtually set in the information processing apparatus 100 to design and analyze the three-dimensional object md. A three-dimensional orthogonal coordinate system having an X axis, a Y axis, and a Z axis, for example, is set in the simulation space. There is no particular limitation on the object md described here; the object md may be, for example, a server, a personal computer (PC) or another electronic device.

The information processing apparatus 100 receives specification information Indicating a surface of a first part, which is one of a plurality of parts included in the object md that is represented by design data and is eligible for analysis. The designated surface is one of the surfaces of the first part and is in contact with a particular part that is not included in the object md and has high elasticity. The design data is also referred to as CAD data 101. For each part included in the object md, the position, color, medium, and the like of the part may be set in the CAD data 101. Parts a1 to a4 are included in the object md as Illustrated in (1) in FIG. 1. As illustrated in (2) in FIG. 1, the first part is the part a1 and a surface m, which is one of the surfaces of the part a1, is designated or specified. The first part is, for example, a heat generating part such a package or a part in contact with a heat generating part. The part in contact with a heat generating part is, for example, a part affected by electric heating when the part is brought into contact with a heat generating part.

The information processing apparatus 100 receives specification information indicating a second part in contact with a particular part, the second part being one of the plurality of parts included in the object md. In the example in (3) in FIG. 1, the second part is the part a2. As described above, the particular part has high elasticity, that is, the particular part is more deformable than the first and second parts.

Next, the information processing apparatus 100 receives specification information indicating the thickness of the particular part before it is compressed. The particular part is a thermally conductive material, an adhesive, or another part as described above. The thickness before the particular part is compressed is also referred to as the thickness before the compression. In the example in (4) in FIG. 1, the thickness before the particular part is compressed is t1.

The information processing apparatus 100 receives an input of correspondence information 102, which represents a correspondence relationship between the amount of compression of the particular part and its thermal resistance. The amount of compression is a difference between the thickness before the compression and the thickness after the compression. In (5) in FIG. 1, the correspondence relationship between the amount of compression and the thermal resistance is indicated as a graph. The correspondence Information 102 may be, for example, table information in which a thermal resistance is Indicated for each amount of compression in a table. Alternatively, the correspondence Information 102 may be, for example, a function that gives a thermal resistance in response to an input of the amount of compression.

The information processing apparatus 100 calculates the thickness of a particular part that is placed between a specified surface and a specified second part and is compressed between them, according to the CAD data 101. Specifically, the information processing apparatus 100 calculates the distance between the specified surface m and the specified second part to obtain the thickness of the particular part after the compression. The thickness after the particular part has been compressed is also referred to as the thickness after the compression. In the example in (6) in FIG. 1, the thickness after the compression is t2.

The information processing apparatus 100 calculates the thermal conductivity of the particular part placed between the specified surface and the specified second part according to the amount of compression and the correspondence information 102. Specifically, the information processing apparatus 100 obtains a thermal resistance R1 of the particular part corresponding to the amount of compression obtained from a difference between the thickness t1 before the compression and the thickness t2 after the compression, according to correspondence information 102. The information processing apparatus 100 then calculates a thermal conductivity r according to the thermal resistance R1, the thickness t2 after the compression, and the area of the surface m. As illustrated in (7) in FIG. 1, the information processing apparatus 100 calculates the thermal conductivity r by calculating “t2/R1/area of surface m”, for example.

In addition, the Information processing apparatus 100 creates second CAD data that Indicates the object md in which the particular part is placed between the specified surface and the specified second part. The Information processing apparatus 100 then sets the thermal conductivity r, which has been calculated as the thermal conductivity of the particular part, in the second CAD data. Thus, a thermal conductivity may be obtained in consideration of the compression of the thermally conductive material, the adhesive, or another part. This enables a thermal simulation may be carried out at a higher precision.

FIGS. 2A and 2B illustrate an example of modeling in analysis and FIG. 2C illustrates an example of uneven thermal resistance. When a TIM, an adhesive, or another part is modeled according to the CAD data 101, much time and efforts are involved as illustrated in FIGS. 2A and 2B. When a thermal conductivity is set after the part is modeled, precision is lowered in a case as in FIG. 2C.

When a TIM, an adhesive, or another part is placed between a heat sink and a package, for example, the heat sink is relocated in the process of modeling by an amount equal to the thickness of the TIM, adhesive, or other part, as illustrated in FIG. 2A. Instead of the example in FIG. 2A, some designers of the CAD data 101 provide a clearance, as a space for a TIM, an adhesive, or another part, between the heat sink and the package in advance regardless of the actual thickness of the TIM, adhesive, or other part. Therefore, it is necessary for the user to carry out the modeling of a TIM, an adhesive, or another part while considering what has been included in the resultant design between the heat sink and the package.

FIG. 2B illustrates a shape in the each case of absence of a heat transfer sheet, a heat transfer sheet before it is compressed, and the heat transfer sheet during mounting. As illustrated in FIG. 2B, when modeling is performed, the size of a TIM, an adhesive, or another part is determined so as to match other parts.

As illustrated in FIGS. 2A and 2B, when the user performs modeling, the user suffers from the problem that much time and efforts are involved.

When, for example, the upper part is inclined as Illustrated in FIG. 2C, a TIM, an adhesive, or another part has different thermal resistances at different places. When a single thermal resistance is determined for a TIM or another part, precision of the design is lowered.

[Hardware Structure of the Information Processing Apparatus 100]

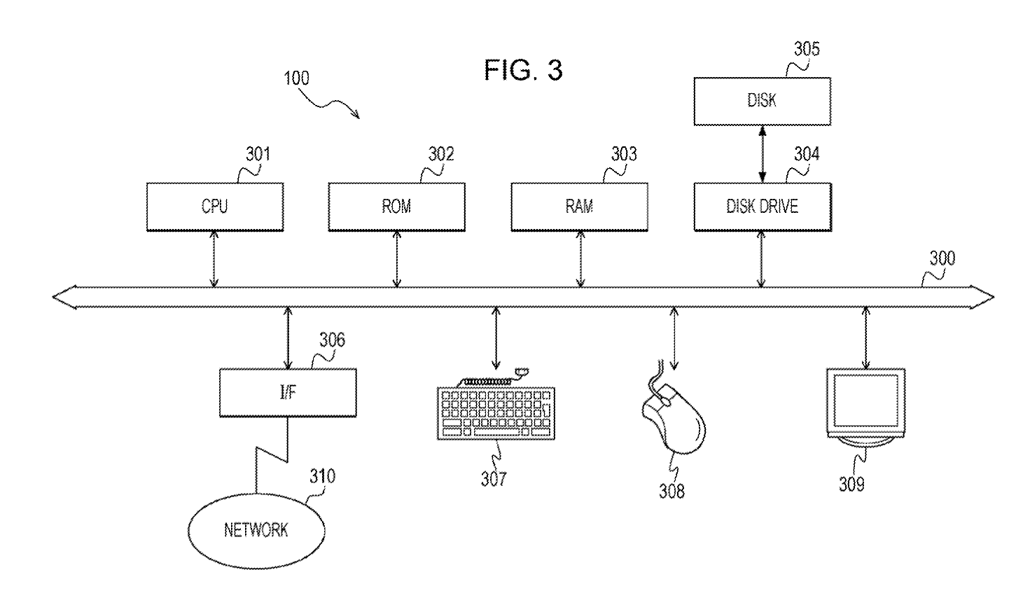

FIG. 3 is a block diagram illustrating an example of the hardware structure of the information processing apparatus 100. In the description below, a PC will be taken as an example of the information processing apparatus 100.

The information processing apparatus 100 includes a central processing unit (CPU) or a processor 301, a read-only memory (ROM) 302, and a random-access memory (RAM) 303. The information processing apparatus 100 also includes a disk drive 304, a disk 305, an interface 306, a keyboard 307, a mouse 308, and a display 309. The CPU 301, ROM 302, RAM 303, disk drive 304, interface 306, keyboard 307, mouse 308, and display 309 are mutually coupled through a bus 300.

The CPU 301 controls the whole of the information processing apparatus 100. The ROM 302 stores a boot program, a design support program, and other programs. The RAM 303 is used as a work area by the CPU 301. The disk drive 304 controls data to be read from and written to the disk 305 under the control of the CPU 301. The disk 305 stores data written under the control of the disk drive 304. Although not Illustrated, the disk 305 may store, for example, a design support program and other programs. Examples of the disk 305 include a magnetic disk and an optical disk. The CPU 301 reads, for example, the design support program stored in the ROM 302, disk 305, or the like and performs processing coded in the design support program.

The interface 306 is connected to a network 310, such as a local area network (LAN), a wide area network (WAN), or the Internet, through a communication line. The interface 306 is connected to another apparatus through the network 310. The interface 306 functions as an interface between the network 310 and the interior of the Information processing apparatus 100 to control the input and output of data to and from the external apparatus. A modem and a LAN adapter, for example, may be used as the interface 306.

The keyboard 307 and mouse 308 are each an interface that accepts various types of data when operated by the user. The display 309 is an interface that outputs data in response to a command from the CPU 301.

In addition to the components described above, the Information processing apparatus 100 may include an input device that fetches still pictures and moving pictures from a camera and an input device that fetches sounds from a microphone. The information processing apparatus 100 may further include an output device such as a printer. The information processing apparatus 100 may further include, for example, a solid state drive (SSD), a semiconductor memory, and the like.

Although, in this embodiment, a PC is taken as an example of the information processing apparatus 100, this is not a limitation; the information processing apparatus 100 may be a server. When the information processing apparatus 100 is a server, the information processing apparatus 100 may be connected to a user-operable device, the display 309, and the like through the network 310. The information processing apparatus 100 may be applied to, for example, a virtual desktop infrastructure (VDI) system. For example, the server performs processing intended to be performed by the information processing apparatus 100 and a client terminal displays a screen suitable for the processing.

[Example of the Functional Structure of the Information Processing Apparatus 100]

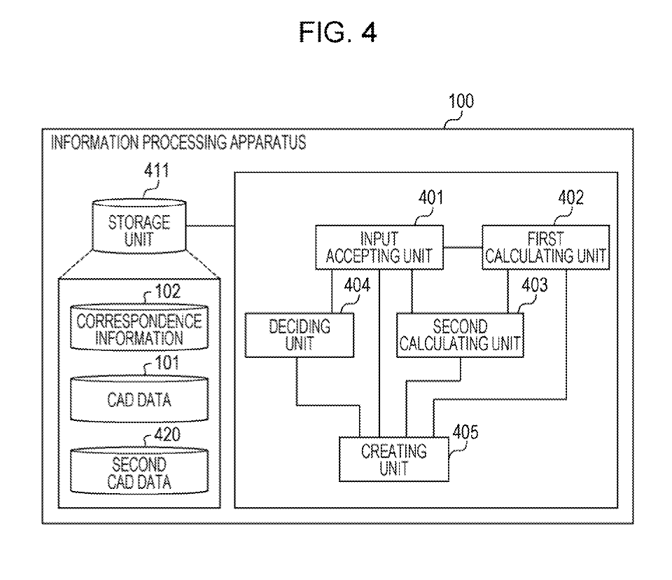

FIG. 4 is a block diagram illustrating an example of the functional structure of the Information processing apparatus 100. The information processing apparatus 100 includes an input accepting unit 401, a first calculating unit 402, a second calculating unit 403, a deciding unit 404, a creating unit 405, and a storage unit 411. Processing to be executed in each unit is coded in a program stored in a storage device such as the ROM 302, RAM 303, and disk 305 which are accessed by the CPU 301, for example, Illustrated in FIG. 3. The CPU 301 reads the program from the above storage device and executes processing coded in the program. Thus, processing by the each unit is implemented. Results of processing by the each unit are stored in a storage device such as, for example, the RAM 303, ROM 302, or disk 305.

The storage unit 411 is a storage device such as, for example, the RAM 303, ROM 302, or disk 305. The storage unit 411 stores, for example, the CAD data 101 and the correspondence information 102. The CAD data 101 is Information representing an object in a simulation space. The correspondence information 102 is, for example, information that associates the amount of compression of the particular part such as the TIM or the adhesive with the thermal resistance of the particular part.

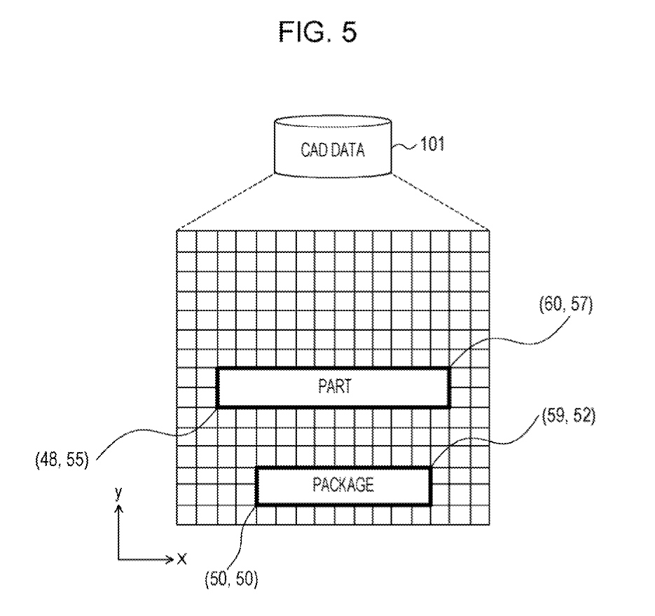

FIG. 5 illustrates an example of CAD data 101. The CAD data 101 is design data that defines that the position of each part included in an object corresponds to which elements in the plurality of elements obtained by dividing the simulation space. A material, a color, and the like may be set in the CAD data 101 for each of the plurality of elements. The thermal conductivity obtained by the calculation described later may also be set in the CAD data 101. Although, in the example in FIG. 5, the CAD data 101 is represented as two-dimensional data for easy understanding, the same is true even when the CAD data 101 is represented as three-dimensional data.

The input accepting unit 401 receives specification information indicating a surface of a first part which is one of a plurality of parts included in an object to be analyzed that is represented by the CAD data 101. The surface of the first part is one of the surfaces of the first part and is in contact with a particular part that is not included in the object and has high elasticity or is easily deformable. The first part is a heat generating part or a part in contact with a heat generating part. The particular part is at least any one of a thermally conductive material and an adhesive.

Next, the input accepting unit 401 then receives specification Information indicating a second part in contact with the particular part. The second part is one of the plurality of parts included in the object to analyzed. The input accepting unit 401 then receives specification information indicating the thickness of the particular part before it is compressed. The input accepting unit 401 receives an input of the correspondence information 102, which represents a correspondence relationship between the amount of compression of the particular part and its thermal conductivity.

Next, the first calculating unit 402 calculates the thickness of the particular part after it has been compressed in a case in which it is placed between the specified surface and the specified second part, according to the CAD data 101.

Next, the second calculating unit 403 calculates the thermal conductivity of the particular part in a case in which the particular part having the thickness after the compression is placed between the specified surface and the specified second part, according to the correspondence information 102 and the amount of compression of the particular part, the amount being obtained from the thickness of the particular part before the compression and its thickness after the compression.

Specifically, the second calculating unit 403 derives a thermal resistance corresponding to the amount of compression obtained from the accepted thickness before the compression and the calculated thickness after the compression, according to the correspondence information 102. The second calculating unit 403 then calculates the thermal conductivity according to the derived thermal resistance, the area of the specified surface, and the calculated thickness after the compression.

The creating unit 405 creates second CAD data 420 that represents an object in which the particular part having the calculated thickness after the compression is placed between the specified surface and the specified second part, according to the CAD data 101.

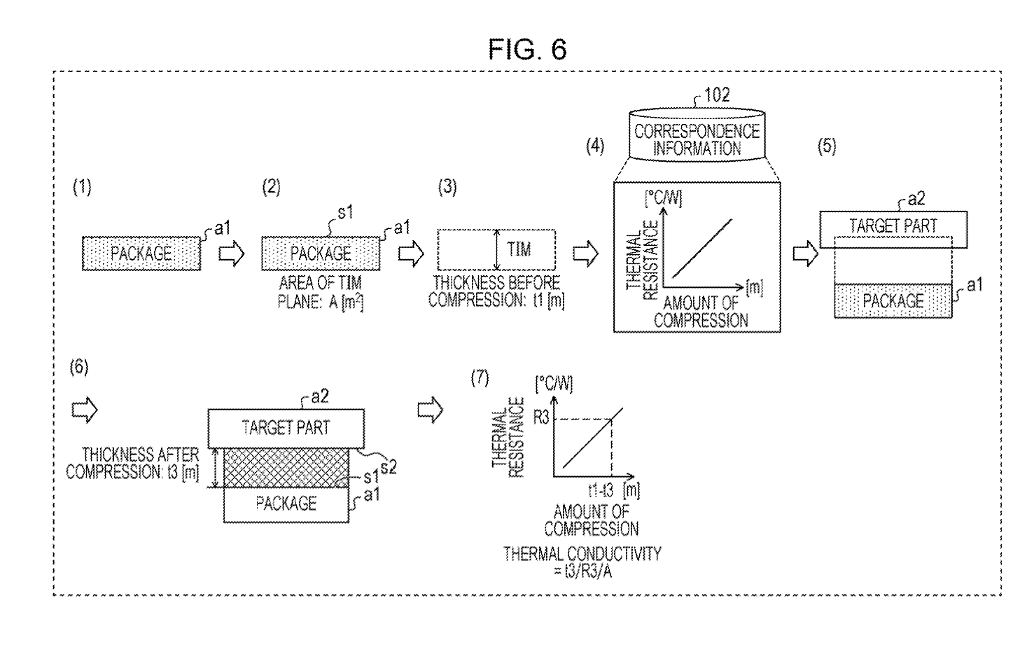

FIG. 6 illustrates an example of calculating a thermal conductivity when a TIM is taken as an example of a particular part and the thickness of a compressed TIM is not input. The input accepting unit 401 receives specification information indicating a first part, for example, which is one of a plurality of parts included in an object to be analyzed. In the example in (1) in FIG. 6, a package a1 as a heat generating part is specified as the first part.

Next, the input accepting unit 401 receives specification information indicating a surface of the package a1 as one in contact with a part such as a TIM or an adhesive among the surfaces of the package a1. The specification information indicating the surface which is accepted by the input accepting unit 401 is made by the user's operation through an input device such as the keyboard 307 or mouse 308. In the example in (2) in FIG. 6, a surface s1 is specified.

Next, the input accepting unit 401 receives, for example, an input of the thickness of the TIM before it is compressed. The input accepting unit 401 may accept the input of the thickness before the compression by the user's operation of an input device such as the keyboard 307 or mouse 308, for example. Alternatively, the input accepting unit 401 may acquire a reference value that is stored in advance in the storage unit 411. In the example in (3) in FIG. 6, t1 is set as an example of the thickness before the compression.

Next, the input accepting unit 401 receives an input of the correspondence information 102, which represents a correspondence relationship between the amount of compression of the TIM and its thermal resistance. In (4) in FIG. 6, the correspondence relationship represented by the correspondence information 102 is illustrated as a graph. As illustrated by the correspondence information 102, as the amount of compression is increased, the thermal conductivity becomes larger.

Next, the input accepting unit 401 receives specification information indicating a second part in contact with the particular part, in which the particular part is a TIM or an adhesive and the second part is one of the plurality of parts included in the object. The second part will also be referred to as the target part. In (5) in FIG. 6, an example in which the target part a2 is specified is illustrated.

Since the input accepting unit 401 has not received an input of the thickness of the TIM after the compression, the first calculating unit 402 calculates the thickness of the TIM in a case in which the TIM is placed between the surface s1 and the target part a2 and is compressed, according to the CAD data 101. The first calculating unit 402 calculates the distance between the bottom surface s2 of the target part a2 and the surface s1 of the package a1 according to the CAD data 101. The first calculating unit 402 calculates this distance as the thickness of the particular part after the compression. The thickness after the particular part has been compressed is also referred to as the thickness after the compression. As illustrated in (6) in FIG. 6, the thickness after the compression is t3 [m].

The second calculating unit 403 calculates the thermal conductivity of the particular part placed between the surface s1 and the target part a2, according to the correspondence information 102 and the amount of compression of the particular part, which is obtained based on the thicknesses before the compression from the input accepting unit 401 and the thickness calculated by the first calculating unit 402.

Specifically, the second calculating unit 403 derives the thermal resistance corresponding to the amount of compression obtained from the thickness before the compression and the thickness after the compression, according to the correspondence information 102. A value obtained by subtracting the thickness t3 after the compression from the thickness t1 before the compression is the amount of compression. The second calculating unit 403 calculates a thermal resistance R3 corresponding to the amount of compression (t1−t3) according to the correspondence information 102.

Next, the second calculating unit 403 calculates a thermal conductivity based on the derived thermal resistance R3, the area A of the surface Si, and the thickness t3 after the compression. More specifically, as illustrated in (7) in FIG. 6, the second calculating unit 403 calculates the thermal conductivity of the TIM from “t3 [m]/R3[° C./W]/A [m²]”.

The creating unit 405 creates the second CAD data 420 that represents an object in which a TIM having the thickness calculated by the first calculating unit 402 is placed between the target part a2 and the package a1. In the second CAD data 420, the creating unit 405 sets the thermal conductivity calculated by the second calculating unit 403 in an element in which the set TIM is placed.

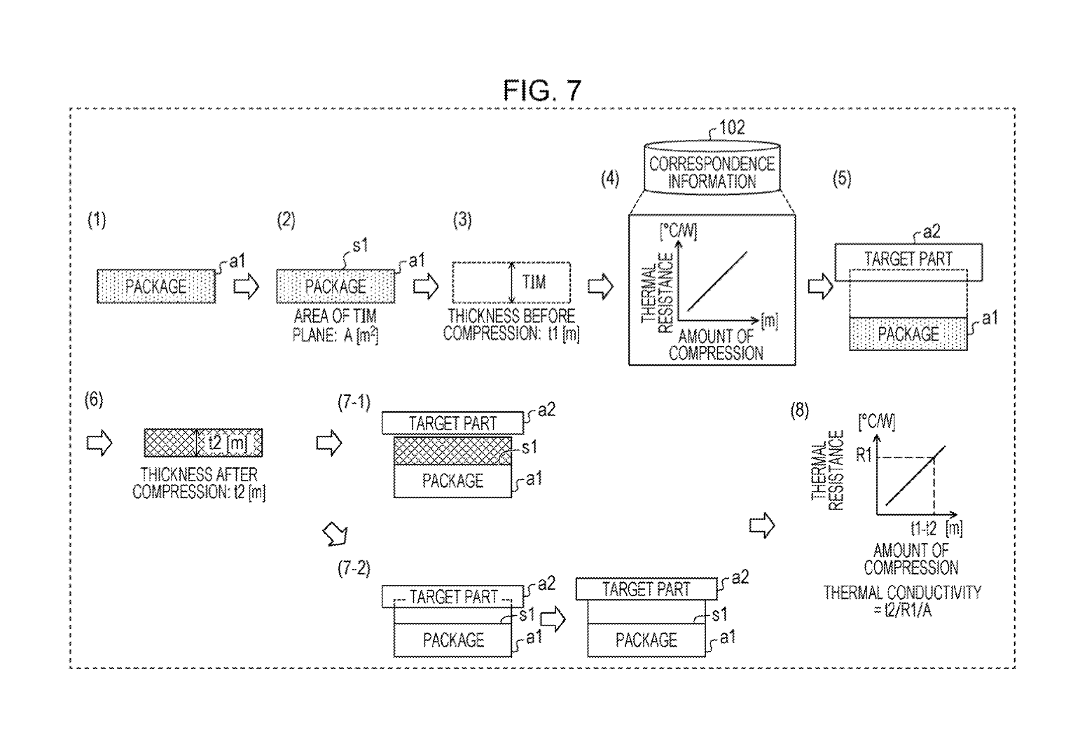

FIG. 7 illustrates an example of calculating a thermal conductivity when the thickness of a compressed TIM is input. In this example, a TIM is taken as an example of a particular part. (1) to (5) in FIG. 7 are the same as (1) to (5) in FIG. 6, and their detailed descriptions will be omitted.

The input accepting unit 401 receives an input of the thickness of the TIM after the TIM has been compressed without performing the processing to calculate the thickness after the compression. In the example in (6) in FIG. 7, the thickness after the compression is t2.

The deciding unit 404 then decides whether the TIM and the specified target part a2 overlap according to the CAD data 101 when the accepted TIM having the thickness after the compression is placed on the specified surface s1.

In (7-1) in FIG. 7, an example in which the TIM and target part a2 do not overlap is illustrated. When the deciding unit 404 decides that the TIM and target part a2 do not overlap, the creating unit 405 creates the second CAD data 420 that Indicates an object in which a TIM having the accepted thickness after the compression is provided.

In (7-2) in FIG. 7, an example in which the TIM and target part a2 overlap is Illustrated. When the deciding unit 404 decides that the TIM and target part a2 overlap, the creating unit 405 creates the second CAD data 420 that indicates an object in which the target part a2 is positioned on the upper surface of the TIM, the upper surface being one of the surfaces of the TIM, in a case in which a TIM having the thickness after the compression is placed on the specified surface s1.

The second calculating unit 403 calculates the thermal conductivity of the TIM in a case in which the TIM is placed between the specified surface and the specified target part a2, according to the accepted correspondence information 102 and the amount of compression, which is obtained from the accepted thickness before the compression and the accepted thickness after the compression.

As illustrated in (8) in FIG. 7, the amount of compression is obtained by subtracting the thickness t2 after the compression from the thickness t1 before the compression. The thermal resistance corresponding to the amount of compression (t1−t2) is R1. The second calculating unit 403 calculates a thermal conductivity according to the derived thermal resistance R1, the area A of the specified surface s1, and the thickness t2 after the compression. Specifically, the second calculating unit 403 calculates the thermal conductivity from “t2 [m]/R1 [° C./W]/A [m²]”.

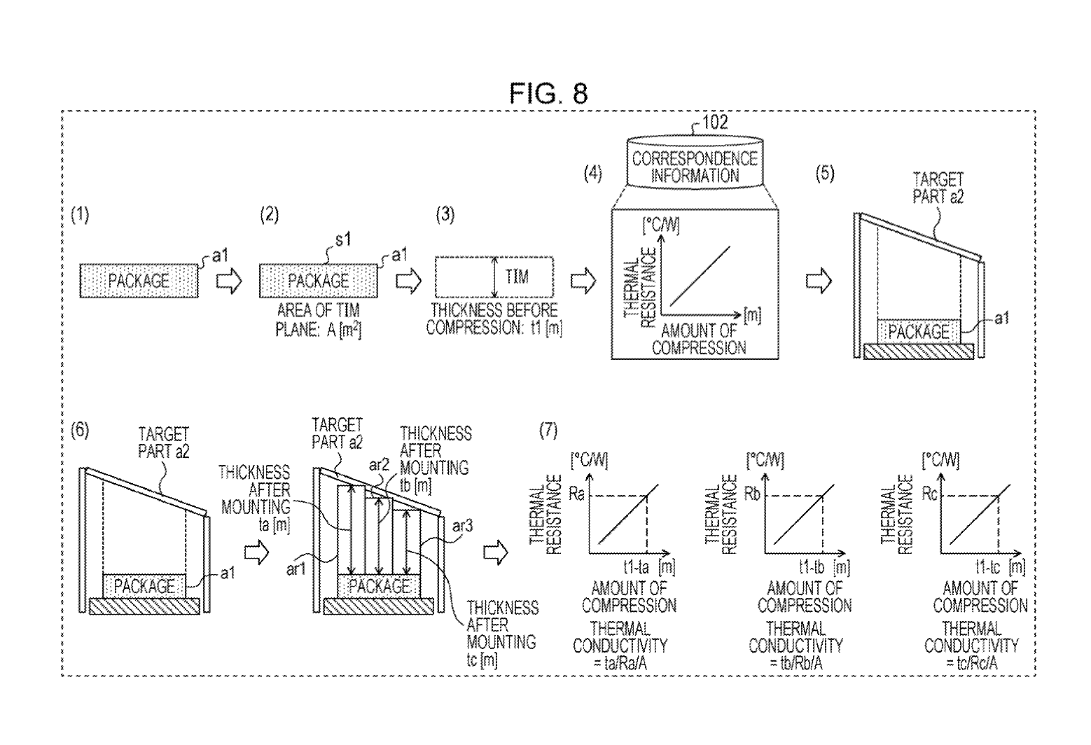

FIG. 8 illustrates an example of calculating thermal conductivities at different distances between a heat generating part and a target part. (1) to (4) in FIG. 8 are the same as (1) to (4) in FIG. 6, and their detailed descriptions will be omitted.

Next, the input accepting unit 401 receives specification information indicating the target part a2 which is one of a plurality of parts included in an object and in contact with a TIM. The target part a2 illustrated in (5) in FIG. 8 is inclined. Since the thickness of the TIM differs at different positions, it is desirable to change the thermal conductivity of the TIM accordingly as described above with reference to FIG. 2C.

In addition, for each of a plurality of partial parts obtained by dividing a TIM placed between the specified surface Si and the specified target part a2 in a direction perpendicular to the specified surface, the first calculating unit 402 calculates the thickness of the partial part after it has been compressed according to the CAD data 101.

Specifically, the first calculating unit 402 divides, for example, an area between the surface s1 and the target part a2 into a plurality of rectangular parallelepipeds. In (6) in FIG. 8, an example in which the area is divided into three rectangular parallelepipeds denoted by ar1 to ar3 is illustrated. For each rectangular parallelepiped, the first calculating unit 402 calculates the distance between the surface s1 and the target part a2 as the thickness of the TIM. As illustrated in (6) in FIG. 8, the thickness of the rectangular parallelepiped ar1 is ta, the thickness of the rectangular parallelepiped ar2 is tb, and the thickness of the rectangular parallelepiped ar3 is tc.

The second calculating unit 403 calculates the thermal conductivity of each of the plurality of partial parts in a case in which the partial part is placed between the specified surface s1 and the specified target part a2, according to the correspondence information 102 and the amount of compression obtained from the thickness before the compression and the thickness after the compression. As illustrated in (7) in FIG. 8, the amount of compression of the rectangular parallelepiped ar1 is “t1−ta” and its thermal resistance is Ra. The thermal conductivity of the rectangular parallelepiped ar1 is ta/Ra/A.

As illustrated in (7) in FIG. 8, the amount of compression of the rectangular parallelepiped ar2 is “t1−tb” and its thermal resistance is Rb. The thermal conductivity of the rectangular parallelepiped ar2 is tb/Ra/A. As Illustrated in (7) in FIG. 8, the amount of compression of the rectangular parallelepiped ar3 is “t1−tc” and its thermal resistance is Rc. The thermal conductivity of the rectangular parallelepiped ar3 is tc/Rc/A.

For each partial part, the creating unit 405 creates the second CAD data 420 that represents an object in which the partial part having the calculated thickness is placed.

[Example of a Processing Procedure Executed by the Information Processing Apparatus 100 to Calculate a Thermal Conductivity]

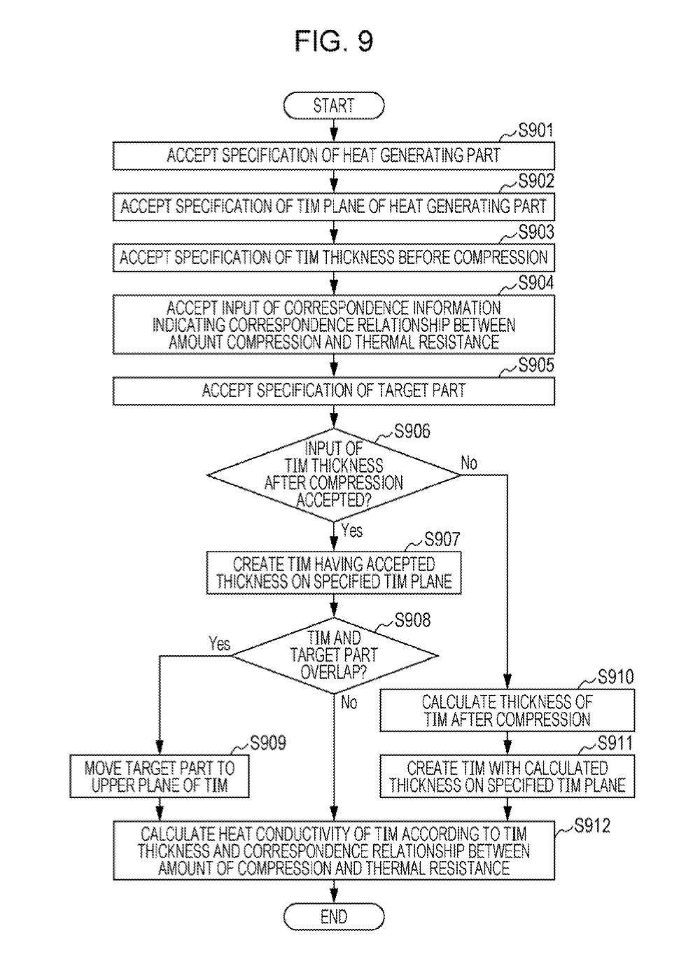

FIG. 9 is a flowchart illustrating an example of a processing procedure executed by the information processing apparatus 100 to calculate a thermal conductivity. The information processing apparatus 100 receives specification information indicating a heat generating part (step S901). The information processing apparatus 100 then receives specification information indicating a TIM surface of the heat generating part (step S902). The information processing apparatus 100 then receives specification information indicating a TIM thickness before the TIM is compressed (step S903).

The information processing apparatus 100 accepts an input of the correspondence information 102, which represents a correspondence relationship between the amount of compression and a thermal resistance (step S904). The information processing apparatus 100 receives specification information indicating a target part (step S905). The information processing apparatus 100 decides whether an input of the thickness of the TIM after the compression has been accepted (step S906).

When the information processing apparatus 100 decides that an input of the thickness of the TIM after the compression has been accepted (the result in step S906 is Yes), the information processing apparatus 100 creates a TIM having the accepted thickness on the specified TIM surface (step S907). The information processing apparatus 100 decides whether the TIM and target part overlap (step S908). When the information processing apparatus 100 decides that the TIM and target part do not overlap (the result of step S908 is No), the Information processing apparatus 100 proceeds to step S912. When the information processing apparatus 100 decides that the TIM and target part overlap (the result of step S908 is Yes), the information processing apparatus 100 moves the target part to the upper surface of the TIM (step S909) and proceeds to step S912.

When the information processing apparatus 100 decides, in step S906, that an input of the thickness of the TIM after the compression has not been accepted (the result in step S906 is No), the information processing apparatus 100 calculates the thickness of the TIM after the compression (step S910). Next, the information processing apparatus 100 creates a TIM having the calculated thickness on the specified TIM surface (step S911). The information processing apparatus 100 then calculates the thermal conductivity of the TIM according to the TIM thickness and the correspondence relationship between the amount of compression and the thermal conductivity (step S912), terminating the series of processing.

As described above, the information processing apparatus 100 calculates the thermal conductivity of the TIM according to a correspondence relationship between the amount of compression of the TIM and the thermal resistance of the TIM and to the amount of compression of the TIM in a case in which it is placed between a heat generating part and a target part, the amount being obtained from the calculated thickness of the TIM after the compression and its thickness before the compression. Thus, it is possible to obtain a thermal conductivity in consideration of the compression of the TIM.

In addition, the information processing apparatus 100 derives the thermal resistance corresponding to the amount of compression obtained from an accepted thickness before the compression and a calculated thickness after the compression. The information processing apparatus 100 then calculates a thermal conductivity according to the derived thermal resistance, the area of a specified surface, and a calculated thickness after the compression.

In addition, for each of a plurality of partial parts obtained by dividing a particular part in a direction perpendicular to a specified surface, the information processing apparatus 100 calculates the thickness of the partial part after the partial part has been compressed. The information processing apparatus 100 subsequently calculates the thermal conductivity of each of the partial parts according to the calculated thickness after the compression.

In addition, the information processing apparatus 100 creates the second CAD data 420 that indicates an object in which a particular part having a calculated thickness after the compression is placed between a specified surface and a specified second part, according to the CAD data 101.

In addition, when the information processing apparatus 100 accepts an input of a thickness after the compression and a particular part having the accepted thickness after the compression is placed on a specified surface, when the particular part and a second part overlap, the information processing apparatus 100 creates the second CAD data 420 that indicates an object in which the position of the second part is on the upper surface of the particular part.

The thermal conductivity calculation method described in this embodiment may be implemented by having a personal computer, a workstation, or another type of computer execute a thermal conductivity calculation program prepared in advance. The thermal conductivity calculation program is recorded in a magnetic disk, an optical disk, a universal serial bus (USB) flash memory, or another type of computer-readable recording medium. The thermal conductivity calculation program is executed by being read from the recording medium by the computer. The thermal conductivity calculation program may be distributed through the Internet or another network.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a program for causing a computer to execute a process for thermal conductivity calculation, the process comprising:
receiving specification Information indicating a surface of a first part, the first part being one of a plurality of parts included in an object to be analyzed, the object being represented by design data, the surface being one of surfaces of the first part and in contact with a particular part that is not included in the object;
receiving specification information indicating a second part in contact with the particular part, the second part being one of the plurality of parts, the particular part being more deformable than the first part and the second part;
receiving specification information indicating a first thickness of the particular part before the particular part is compressed;
calculating, according to the design data, a second thickness of the particular part after the particular part has been compressed in a case in which the particular part is placed between the surface and the second part and has been compressed; and
calculating a thermal conductivity of the compressed particular part having the second thickness, according to an amount of compression of the particular part Indicating a difference between the first thickness and the second thickness and to correspondence information that represents a correspondence relationship between a thermal resistance of the particular part and an amount of compression obtained by subtracting a thickness of the particular part which is compressed from the first thickness.

2. The non-transitory computer-readable recording medium having stored therein a program for causing a computer to execute a process for thermal conductivity calculation according to claim 1, wherein
in the calculating, deriving a thermal resistance that corresponds to the amount of compression of the particular part according to the correspondence information, and
calculating the thermal conductivity by using the thermal resistance, an area of the surface, and the second thickness.

3. The non-transitory computer-readable recording medium having stored therein a program for causing a computer to execute a process for thermal conductivity calculation according to claim 1, wherein
in the calculating the second thickness, calculating, according to the design data, a third thickness of each of a plurality of partial parts after the partial part has been compressed, the plurality of partial parts being obtained by dividing the particular part in a direction perpendicular to the surface, and
in the calculating the thermal conductivity, calculating, calculating a thermal conductivity of the each of the plurality of partial parts, by using each of compression amounts obtained from the first thickness and the third thickness of the each of the plurality of the partial parts of the each of the plurality of partial parts and the correspondence information.

4. The non-transitory computer-readable recording medium having stored therein a program for causing a computer to execute a process for thermal conductivity calculation according to claim 1, the processing further comprising:
creating a second design data that represents the object in a case in which the particular part having the thickness after the particular part has been compressed is placed between the surface and the second part, according to the design data.

5. The non-transitory computer-readable recording medium having stored therein a program for causing a computer to execute a process for thermal conductivity calculation according to claim 1, the processing further comprising:
receiving specification information indicating the second thickness Instead of the calculating the second thickness;
deciding whether, when the particular part having the second thickness is placed on the surface, the particular part and the second part overlap according to design data representing the object; and
creating, when the particular part and the second part are decided to overlap in the deciding, second design data that indicates the object in which a position of the second part, the specification of which has been accepted, is on an upper surface of the particular part having the thickness after the particular part has been compressed, the upper surface being one of surfaces of the particular part; and wherein
in the calculating the thermal conductivity, the thermal conductivity of the particular part placed between the surface and the second part is calculated according to the correspondence information and the amount of compression.

6. The non-transitory computer-readable recording medium having stored therein a program for causing a computer to execute a process for thermal conductivity calculation according to claim 1, wherein the particular part is at least any one of a thermally conductive material and an adhesive.

7. The non-transitory computer-readable recording medium having stored therein a program for causing a computer to execute a process for thermal conductivity calculation according to claim 1, wherein the first part is a heat generating part or a part in contact with a heat generating part.

8. A thermal conductivity calculation method comprising:
receiving, by a computer, specification information indicating a surface of a first part, the first part being one of a plurality of parts included in an object to be analyzed, the object being represented by design data, the surface being one of surfaces of the first part and in contact with a particular part that is not included in the object;
receiving specification information Indicating a second part in contact with the particular part, the second part being one of the plurality of parts, the particular part being more deformable than the first part and the second part;
receiving specification information indicating a first thickness of the particular part before the particular part is compressed;
calculating, according to the design data, a second thickness of the particular part after the particular part has been compressed in a case in which the particular part is placed between the surface and the second part and has been compressed; and
calculating a thermal conductivity of the compressed particular part having the second thickness, according to an amount of compression of the particular part indicating a difference between the first thickness and the second thickness and to correspondence information that represents a correspondence relationship between a thermal resistance of the particular part and an amount of compression obtained by subtracting a thickness of the particular part which is compressed from the first thickness.

9. An Information processing apparatus comprising:
a processor configured to
receive specification information indicating a surface of a first part, the first part being one of a plurality of parts included in an object to be analyzed, the object being represented by design data, the surface being one of surfaces of the first part and in contact with a particular part that is not included in the object,
receive specification information indicating a second part in contact with the particular part, the second part being one of the plurality of parts, the particular part being more deformable than the first part and the second part,
receive specification information indicating a first thickness of the particular part before the particular part is compressed,
calculate, according to the design data, a second thickness of the particular part after the particular part has been compressed in a case in which the particular part is placed between the surface and the second part and has been compressed, and
calculate a thermal conductivity of the compressed particular part having the second thickness, according to an amount of compression of the particular part Indicating a difference between the first thickness and the second thickness and to correspondence information that represents a correspondence relationship between a thermal resistance of the particular part and an amount of compression obtained by subtracting a thickness of the particular part which is compressed from the first thickness.
